(19) United States
(12) Patent Application Publication
(10) Pub. No.: US 2026/0148097 A1
(43) Pub. Date: May 28, 2026

(54) A FRAMEWORK FOR IMPROVING LOGIC INDUCTION CAPABILITIES IN ARTIFICIAL INTELLIGENCE MODELS

(71) Applicant: PayPal, Inc., San Jose, CA (US)

(72) Inventors: Zhe CHEN, Singapore (SG); Juan XU, Shanghai (CN); Xin KANG, Shanghai (CN); Rao FU, Shanghai (CN)

(21) Appl. No.: 18/870,345

(22) PCT Filed: Oct. 23, 2024
(86) PCT No.: PCT/CN2024/126634

§ 371 Date: Nov. 27, 2024

(51) Int. Cl. G06N 5/022

(52) U.S. Cl. CPC G06N 5/022

(57) ABSTRACT

Methods and systems are presented for providing a framework that improves the logic induction capabilities of an artificial intelligence (AI) model. Under the framework, different logics are encapsulated in a logic knowledge graph. Embeddings are extracted from different portion of the logic knowledge graph, and guiding questions are generated for each logic that is encapsulated within the graph based on the embeddings. A logic database is constructed using the embeddings and the guiding questions. In order for the AI model to perform a task, the logic database is queried to obtain a set of guiding questions corresponding to the task. The guiding questions, along with other information associated with the task, are incorporated into a prompt, which is then provided to the AI model. Based on the guiding questions included in the prompt, the AI model can generate content that follows a particular logic.

### BACKGROUND

The present specification generally relates to an artificial intelligence model framework, and more specifically, to providing a framework that improves the logic induction capabilities in artificial intelligence models according to various embodiments of the disclosure.

### RELATED ART

Artificial intelligence (AI) models, such as large language models (LLMs), have increasingly been used by organizations to perform different complex tasks, such as facilitating automated dialogue-based interactions with users, synthesizing information and providing summaries of the synthesized information to users, etc. Typical LLMs, such as GPT-4, BERT, LLAMA, etc., are powerful and flexible as they are capable of understanding and synthesizing a large amount of data from different sources, and generating summaries of the information in a natural language format. For example, by consuming the vast information available on the Internet through a training process, a typical AI model is capable of learning and generating content (e.g., responses to user-queries) across a wide range of subject matters.

However, while these generic AI models are trained to provide information in a wide range of subject matters based on synthesizing a large amount of data, they have limited logic induction capabilities, which prevents AI models from becoming more useful in assisting humans by performing even more complex tasks. For example, by enabling an AI model to perform logic inductions based on past events (e.g., drawing conclusions as to reasoning why certain events occurred), the AI model can not only provide more accurate predictions on future events, but also provide in-depth analysis and suggestions on how to improve the event-occurring rate (e.g., increasing or reducing the rate, etc.), resulting in AI models that are more accurate and are capable of expanded functionality. Thus, there is a need for a framework that improves AI models'logic induction capabilities.

### BRIEF DESCRIPTION OF THE FIGURES

FIG. 1 is a block diagram illustrating an electronic transaction system according to an embodiment of the present disclosure;

FIG. 2 is a block diagram illustrating a logic module according to an embodiment of the present disclosure;

FIG. 3 is a block diagram illustrating a logic generation module according to an embodiment of the present disclosure;

FIG. 4A illustrates an example graph that represents a logic flow according to an embodiment of the present disclosure;

FIG. 4B illustrates merging of different graphs according to an embodiment of the present disclosure;

FIG. 5 is a flowchart showing a process of generating a logic database according to an embodiment of the present disclosure;

FIG. 6 is a flowchart showing a process of using the logic database to enable an artificial intelligence model to perform tasks that require logic induction according to an embodiment of the present disclosure;

FIG. 7 illustrates an example neural network that can be used to implement a machine learning model according to an embodiment of the present disclosure; and

FIG. 8 is a block diagram of a system for implementing a device according to an embodiment of the present disclosure.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

The present disclosure describes methods and systems for providing a framework that improves the logic induction capabilities of an artificial intelligence (AI) model. As discussed above, AI models are typically capable of synthesizing a large amount of data, but lack capabilities in logic induction. For example, an AI model can produce accurate summaries of information (e.g., summaries of activities that occurred in the past, etc.) that it has digested, but cannot generate reasoning based on the information (e.g., reasons, such as logic, behind why the activities occurred where the reasons are not included in the information digested by the AI model, etc.). In a particular use case, organizations may generate reports to document activities that are associated with a particular activity type (e.g., suspicious activities, etc.). The reports may be generated for internal use within an organization, for providing future planning or changes of policies for an organization, for compliance of local ordinance, etc. Each report may be required to include a description of events that, when occurring together (e.g., in a sequence), would likely be classified as a particular type of activity (e.g., a fraudulent transaction, a money laundering activity, a financial crime, etc.), and an explanation of the reasoning regarding why the events collectively lead to a determination that the activity is classified as the particular type of activity. The generation of this type of reports has been historically challenging for AI models, since AI models have limited capabilities in providing reasoning with accurate and coherent logic, based on past activities. However, such information is valuable to better understand why a certain prediction was made, which can be used to address negative predictions (such as fraud), and to better train AI models for more accurate predictions.

As such, in order to enable AI models to perform tasks that use logic induction, a framework is provided to improve the logic induction capabilities in an AI model. Under the framework, the logic induction capabilities are provided to the AI model in two stages: a preparation stage and a generation stage. In the preparation stage, narratives (e.g., descriptions) associated with past activities are used to generate a graph-based logic database, which can be used subsequently by the AI model for performing tasks that use logic induction. Using the suspicious activity report example illustrated above, the narratives of historical activities may include descriptions of occurrences of different events.

As mentioned above, there are different types of activities that would give rise to the need of generating the reports, such as fraudulent transactions, money laundering activities, financial crimes, etc. By observing past suspicious activities, different combinations of events may be identified that would contribute to a high likelihood of certain suspicious activities. For example, based on historic occurrences of different money laundering activities, it can be observed that a combination of Event A+Event B+Event C, or a combination of Event B+Event D+Event E may indicate a high likelihood of a money laundering activity. In another example, based on different fraudulent transactions that have been conducted in the past, it can be observed that a combination of Event A+Event C+Event F or a combination of Event C+Event F+Event G may indicate a high likelihood of a fraudulent transaction. Each event may represent an identifiable action or lack of action, such as a transaction conducted by a single entity or multiple entities (e.g., a cash withdrawal, a transfer of money between two entities, a mass transfer of funds, a lack of descriptions provided in a transfer, etc.).

In the preparation stage, a system associated with the framework may compile narratives associated with historical activities. The narrative associated with each activity may include descriptions of one or more events that led up (e.g., contributed) to a particular type of activity. For example, the narrative of a potential money laundering activity may include “upon receipt of payments, User ‘AAA’ transferred the funds back to User ‘BBB;’ none of the payments included notes to provide insight as to what the payments were for; upon receipt of the payments, User ‘BBB’ withdrew the funds and transferred money back to User ‘AAA.’”

In some embodiments, for each activity, the system extracts aspects of the activity based on the narrative. Aspects are abstractions of individual characteristics associated with one or more events that led up (or contributed) to the occurrence of the activity. Each aspect may represent an individual characteristic that can be combined with other aspects in a logic flow that gives rise to the occurrence of an activity. However, each aspect may lack details that are unique to the activity (e.g., identities of the parties involved in a transaction, a specific amount of funds associated with a transaction, etc.). In some embodiments, the system uses a machine learning model (e.g., a language model) to generate the aspects based on the narratives. The machine learning model may derive multiple individual components (e.g., characteristics) that contribute to the activity based on the narrative, and may generate descriptions for each of the individual components based on summarizing the descriptions associated with each individual component and removing any information specific to the activity. For example, the machine learning model may generate, based on the narrative example provided above, the following aspects:
(1) Funds Transfers Between Parties: upon receipt of the payments, Party A transferred the funds back to Party B. Upon receipt of the payments, Party B transferred the funds back to Party A after withdrawing the funds.
(2) Lack of Payment Notes: none of the payments included notes to provide insight into what the payments were for.
(3) Funds Withdrawal: upon receipt of the payments, Part B withdrew the funds.

After extracting the aspects of the activity, the system may generate a graph to represent the logics (e.g., the logical relationships among the aspects) associated with the activity. The logical relationships may include a directional flow among the aspects. For example, for the aspects extracted from the money laundering activity illustrated above, the system may generate a graph that includes nodes for representing the aspects, and generate connections (e.g., edges) to link the related aspects. The system may link the first aspect representing funds transfers between parties to the second aspect representing the lack of payment notes (as the lack of payment notes depend on the funds transfers between the parties), link the second aspect representing the lack of payment notes to the third aspect representing funds withdrawal (as the funds withdrawal comes after the funds transfers that lack payment notes), and link the third aspect representing funds withdrawal back to the first aspect representing funds transfers between parties (as another funds transfer occurred after the funds withdrawal). The system may continue to generate additional graphs that represent logics associated with other activities based on the narratives of the other activities.

After generating graphs that represent logics associated with different activities, the system may merge the graphs together to form a logic knowledge graph. The merging may include removing duplicated graphs. For example, since different combinations of events that lead up to the activities of the same type often include the same aspects and the same relationships among the aspects (e.g., same aspect flows that differ only in the parties'identities and amounts, etc.), the system may retain only one graph to represent those activities that are associated with the same aspect flow (e.g., the same event combinations). In some embodiments, the system adjusts the weight of a link (e.g., a connection, an edge, etc.) in the logic knowledge graph between two aspects when multiple activities are associated with the same relationship between the two aspects. For example, a link between two aspects that have occurred a large number of times may be assigned a higher weight than a link between two aspects that have only occurred once or twice.

In some embodiments, the merging also includes generating a larger graph by combining multiple graphs. For example, if two graphs associated with two different activities share one or more aspects, the system may merge the shared aspect(s) (e.g., combining the different nodes representing the same shared aspect into a single node, etc.) such that the merged graph may include aspects/relationships that represent two or more different logics associated with different activities and/or different activity types. After the merging, the shared aspect(s) may be connected to different aspects based on the different graphs that were merged.

Based on the merging of different graphs representing different activities, the logic knowledge graph enables the system to determine comprehensive characteristics of each aspect. For example, since the same aspect may be associated with different combinations of events related to different activities, the system may use the logic knowledge graph to determine the aspect's relationships with other different aspects that are associated with the different event combinations. This approach enables the system to comprehensively understand the relationships (e.g., interactions) among the aspects.

To extract the characteristics of the aspects and the different logics represented by the logic knowledge graph, the system may first generate embeddings for each aspect in the logic knowledge graph. The embeddings may represent attributes associated with each aspect, such as its relationships to other aspects in the logic knowledge graph, a strength of each of the relationships, characteristics of a portion of the logic knowledge graph in which the aspect is located, etc. The system may then use a graph neural network to analyze the embeddings associated with the aspects in the logic knowledge graph. For example, the system may use the graph neural network to analyze the similarities and/or differences between different logics represented by the different graphs (or sub-graphs) within the logic knowledge graph based on the embeddings. The system may then capture the analytical information as additional embeddings, and associate the embeddings with different portions of the logic knowledge graph (e.g., the different sub-graphs). In some embodiments, by learning and analyzing the logic embeddings across different activities and activity types, the system may also infer additional logics. For example, the system may expand the logic knowledge graph by generating new connections between aspects based on the analyses of the existing connections among the aspects. As a result of the comprehensive understanding of the logic across different cases using the logic knowledge graph, the system may now enable the AI model to perform tasks that use logic induction (e.g., generating the reports for suspicious activities, etc.).

In some embodiments, the system constructs a logic database for the AI model based on the knowledge captured from the logic knowledge graph. The logic database may serve as a logic knowledge base for the AI model, such that the AI model can use the information from the logic database to perform tasks by following one or more logics. The logic database may include the different sub-graphs (i.e., the different graphs that were initially generated to represent the logics associated with different event combinations and/or different activities, etc.). Since each sub-graph includes unique logic embeddings that represent the logical relationships among a combination of different aspects, the AI model may use the knowledge derived from each logic to perform the task.

However, it has been contemplated that the sub-graphs alone may not be sufficient in enabling the AI model to perform tasks based on different logics. As such, the system may also generate a set of guiding questions for each sub-graph (e.g., for each logic) that can assist the AI model in understanding and utilizing the corresponding logics represented by the sub-graphs. Guiding questions are effective for AI models because they provide context, structure, and focus. Furthermore, guiding questions help the AI model to break down the logic and reasoning into distinct steps, enabling the AI model to generate narratives (e.g., reports) with accurate and coherent logic. Using the example illustrated above, the system may generate the following guiding questions for the logic that represents the potential money laundering activity as illustrated above:
1. Who are the parties involved in the fund transfers?
2. How frequently are the funds transferred between these parties?
3. What is the total amount of funds transferred between these parties?
4. Are there any notes or descriptions accompanying the payments?
5. If not, how might the absence of notes impact the understanding of the purpose of these transactions?
6. How soon after the receipt of funds are the withdrawals made?
7. What are the destinations of the withdrawn funds?
8. How frequently does this cycle of transferring, withdrawing, and re-transferring occur?

In some embodiments, the system may use a machine learning model (e.g., a large language model) to generate the guiding questions based on the logic sub-graph. The guiding questions may be modified by a human agent if needed. The system may then store the sub-graphs and the corresponding guiding questions in the logic database. In some embodiments, the system may store the sub-graphs and the corresponding guiding questions according to a key/value scheme, where embeddings associated with the sub-graphs are stored as keys and the corresponding guiding questions are stored as values for the keys. This way, the AI model may query the logic database for guiding questions based on matching embeddings associated with a new narrative with one or more keys in the logic database.

In the generation stage under the framework, the system may receive a request to perform a task that uses logic induction, for example, to generate reasoning of an occurrence of an activity based on a new narrative (e.g., descriptions of a series of events conducted by one or more entities). The system may generate a prompt for the AI model to perform the task. For example, the system may generate a prompt that asks the AI model to create a summary of the events and provide a logical reasoning why the events correspond to a suspicious activity. As such, the narrative of the events may be incorporated into the prompt. In order for the AI model to use a particular logic in performing the task, the system may provide the AI model additional information from the logic database that would assist the AI model to perform the task. For example, the system may identify the logic from the logic database that is related to the combination of events based on the narrative, and may incorporate the guiding questions corresponding to the logic into the prompt to be provided to the AI model.

In some embodiments, the system first generates embeddings based on the narrative that is received in association with the new activity. For example, the system may extract aspects from the narratives, connect the aspects according to a logical flow of the events associated with the new activity, and generate embeddings for the aspects based on the logical flow. The system may then query the logic database for guiding questions based on the embeddings. For example, the logic database may identify one or more keys (e.g., sub-graphs) that match the embeddings of the new activity, and retrieve the guiding questions that correspond to the identified keys. The system may then incorporate the guiding questions into the prompt, and provide the prompt to the AI model. Based on the guiding questions, the AI model may perform the task using the identified logic. For example, the AI model may attempt to answer the guiding questions using the narrative. Based on the answer to the guiding questions, the AI model may be able to induce the logic, and provide an output that explains the reasoning as to why the series of events correspond to the suspicious activity.

For example, based on the following guidance questions: “1. Who are the parties involved in the fund transfers? 2. How frequently are the funds transferred between these parties? 3. What is the total amount of funds transferred between these parties? 4. Are there any notes or descriptions accompanying the payments? 5. If not, how might the absence of notes impact the understanding of the purpose of these transactions?”, the AI model may summarize the input risk factors (e.g., by answering the guiding questions) as: “risk factors: [{‘name’: ‘Top_pair_linked_by_asset’, ‘description’: ‘The detection identifies seed account and its top counterparty ‘XYZ’ that are linked through phone, and they have conducted transactions that totaled $160,996 in past 3 months.’, ‘type’}: ‘ ’, {‘name’: ‘Structuring’, ‘description’: ‘The detection identifies 15 payments sent from the seed account within a 2-day timeframe that add up to $10 k and are sent to the same counterparty. For example, transactions totaling USD $10,090 was conducted within 1491 minutes, with each transaction smaller than 10 k.’, ‘type’: ‘ ’}, {‘name’: ‘Structuring’, ‘description’: ‘The detection identifies 15 payments sent from the seed account within a 2-day timeframe that add up to $ 10k and are sent to the same counterparty.}’”.

Using the answers to the questions, the AI model may then generate a report that includes the following: “The account and its primary counterparty, linked by a common phone number, engaged in transactions totaling $160,996 over the past three months. The account also displayed structuring patterns, with 15 payments totaling $ 10,090 sent to the same counterparty within a 1,491-minute timeframe. Each transaction was under $ 10,000, conducted over two days, and lacked additional descriptive notes, potentially obscuring the purpose of these transactions and raising concerns about attempts to evade reporting thresholds.”

In some embodiments, the system also uses the narrative of the new activity to further improve the logic database. For example, the new activity may be matched with a key in the logic database that represents a particular logic flow. However, the new activity may be associated with a logic that is different from (e.g., not identical to) the particular logic flow. The system may determine that the new activity has a new logic that is not encapsulated within the logic database. As such, the system may modify the logic knowledge graph by incorporating the logic associated with the new activity, and may generate new embeddings (as a new key) and guiding questions (as values) to be stored in the logic database based on the logic.

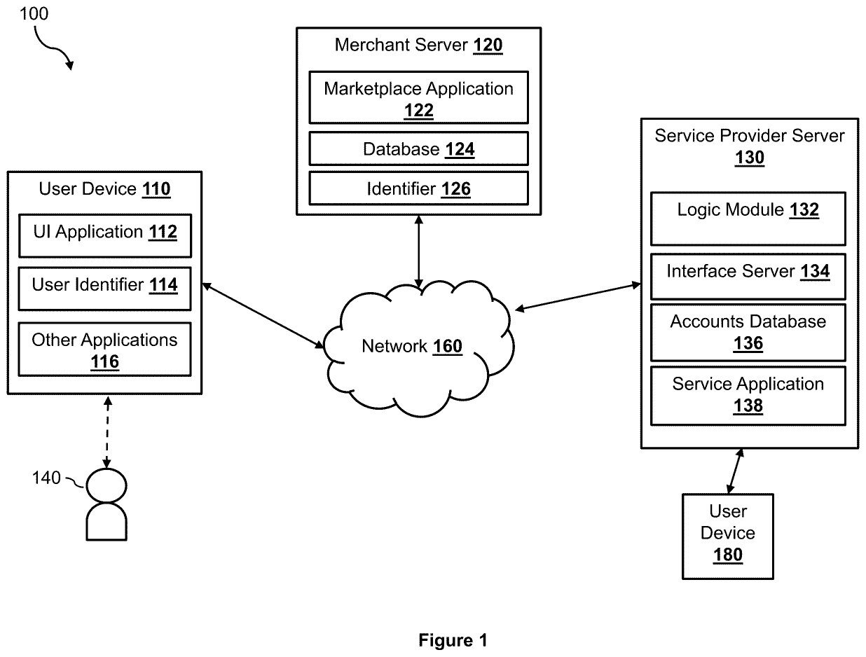

FIG. 1 illustrates an electronic transaction system 100, within which the framework may be implemented according to one or more embodiments of the disclosure. The electronic transaction system 100 includes a service provider server 130, a merchant server 120, and user devices 110 and 180 that may be communicatively coupled with each other via a network 160. The network 160, in one embodiment, is implemented as a single network or a combination of multiple networks. For example, in various embodiments, the network 160 includes the Internet and/or one or more intranets, landline networks, wireless networks, and/or other appropriate types of communication networks. In another example, the network 160 comprises a wireless telecommunications network (e.g., cellular phone network) adapted to communicate with other communication networks, such as the Internet.

The user device 110, in one embodiment, is utilized by a user 140 to interact with the merchant server 120 and/or the service provider server 130 over the network 160. For example, the user 140 uses the user device 110 to conduct an online purchase transaction with the merchant server 120 via websites hosted by, or mobile applications associated with, the merchant server 120. The user 140 also logs in to a user account to access account services or conduct electronic transactions (e.g., data access, account transfers or payments, etc.) with the service provider server 130. The user 140 may be a legitimate or authorized user of a merchant associated with merchant server 120 or of a service provider associated with service provider server 130. The user 140 may also be an unauthorized person or entity or one attempting to conduct a fraudulent transaction or suspicious through merchant server 120 and/or service provider server 130. The user device 110, in various embodiments, is implemented using any appropriate combination of hardware and/or software configured for wired and/or wireless communication over the network 160. In various implementations, the user device 110 includes at least one of a wireless cellular phone, wearable computing device, PC, laptop, etc.

The user device 110, in one embodiment, includes a user interface (UI) application 112 (e.g., a web browser, a mobile payment application, etc.), which may be utilized by the user 140 to interact with the merchant server 120 and/or the service provider server 130 over the network 160. In one implementation, the user interface application 112 includes a software program (e.g., a mobile application) that provides a graphical user interface (GUI) for the user 140 to interface and communicate with the service provider server 130 and/or the merchant server 120 via the network 160. In another implementation, the user interface application 112 includes a browser module that provides a network interface to browse information available over the network 160. For example, the user interface application 112 may be implemented, in part, as a web browser to view information available over the network 160. Thus, the user 140 may use the user interface application 112 to initiate electronic transactions with the merchant server 120 and/or the service provider server 130.

The user device 110, in various embodiments, includes other applications 116 as may be desired in one or more embodiments of the present disclosure to provide additional features available to the user 140. In one example, such other applications 116 include security applications for implementing client-side security features, programmatic client applications for interfacing with appropriate application programming interfaces (APIs) over the network 160, and/or various other types of generally known programs and/or software applications. In still other examples, the other applications 116 interface with the user interface application 112 for improved efficiency and convenience.

The user device 110, in one embodiment, includes at least one identifier 114, which may be implemented, for example, as operating system registry entries, cookies associated with the user interface application 112, identifiers associated with hardware of the user device 110 (e.g., a media control access (MAC) address), or various other appropriate identifiers. In various implementations, the identifier 114 may be passed with a user login request to the service provider server 130 via the network 160, and the identifier 114 may be used by the service provider server 130 to associate the user with a particular user account (e.g., and a particular profile).

In various implementations, the user 140 is able to input data and information into an input component (e.g., a keyboard) of the user device 110. For example, the user 140 may use the input component to interact with the UI application 112 (e.g., to conduct a purchase transaction with the merchant server 120 and/or the service provider server 130, to initiate a chargeback transaction request, request data, etc.). Before authorizing, the interaction may be predicted as suspicious, fraudulent, legitimate, etc. using systems and methods described herein.

It has been contemplated that multiple user devices, each including substantially the same hardware and/or software components as the user device 110, may be connected to the user device 110, the merchant server 120, and the service provider server 130 via the network 160. Each of the user devices connected to the network 160 may interact with the merchant server 120 and/or the service provider server 130 in a similar way as the user device 110.

The merchant server 120, in various embodiments, may be maintained by a business entity (or in some cases, by a partner of a business entity that processes transactions on behalf of the business entity). Examples of business entities include merchants, resource information providers, utility providers, online retailers, real estate management providers, social networking platforms, a cryptocurrency brokerage platform, etc., which offer various items for purchase and process payments for the purchases. The merchant server 120 may include a merchant database 124 for identifying available items or services, which may be made available to the user device 110 for viewing and purchase by the respective users.

The merchant server 120, in one embodiment, may include a marketplace application 122, which may be configured to provide information over the network 160 to the user interface application 112 of the user device 110. In one embodiment, the marketplace application 122 may include a web server that hosts a merchant website for the merchant. For example, the user 140 of the user device 110 may interact with the marketplace application 122 through the user interface application 112 over the network 160 to search and view various items or services available for purchase in the merchant database 124. The merchant server 120, in one embodiment, includes at least one merchant identifier 126, which may be included as part of the one or more items or services made available for purchase so that, e.g., particular items and/or transactions are associated with the particular merchants. In one implementation, the merchant identifier 126 includes one or more attributes and/or parameters related to the merchant, such as business and banking information. The merchant identifier 126 may include attributes related to the merchant server 120, such as identification information (e.g., a serial number, a location address, GPS coordinates, a network identification number, etc.).

While only one merchant server 120 is shown in FIG. 1, it has been contemplated that multiple merchant servers, each associated with a different merchant, may be connected to the user device 110 and the service provider server 130 via the network 160.

The service provider server 130, in one embodiment, is maintained by a transaction processing entity or an online service provider, which provides processing of electronic transactions between users (e.g., the user 140 and users of other user devices, etc.) and/or between users and one or more merchants. As such, the service provider server 130 includes a service application 138, which may be adapted to interact with the user device 110 and/or the merchant server 120 over the network 160 to facilitate the electronic transactions (e.g., electronic payment transactions, data access transactions, etc.) among users and merchants processed by the service provider server 130. In one example, the service provider server 130 is provided by PayPal®, Inc., of San Jose, California, USA, and/or one or more service entities or a respective intermediary that provide multiple point of sale devices at various locations to facilitate transaction routings between merchants and, for example, service entities.

In some embodiments, the service application 138 includes a payment processing application (not shown) for processing purchases and/or payments for electronic transactions between a user and a merchant or between any two entities (e.g., between two users, between two merchants, etc.). In one implementation, the payment processing application assists with resolving electronic transactions through validation, delivery, and settlement. As such, the payment processing application settles indebtedness between a user and a merchant, wherein accounts may be directly and/or automatically debited and/or credited of monetary funds in a manner as accepted by the banking industry.

The service provider server 130 also includes an interface server 134 that is configured to serve content (e.g., web content) to users and interact with users. For example, the interface server 134 includes a web server configured to serve web content in response to HTTP requests. In another example, the interface server 134 includes an application server configured to interact with a corresponding application (e.g., a service provider mobile application) installed on the user device 110 via one or more protocols (e.g., RESTAPI, SOAP, etc.). As such, the interface server 134 may include pre-generated electronic content ready to be served to users. For example, the interface server 134 stores a log-in page and is configured to serve the log-in page to users for logging into user accounts of the users to access various services provided by the service provider server 130. The interface server 134 may also include other electronic pages associated with the different services (e.g., electronic transaction services, etc.) offered by the service provider server 130. As a result, a user (e.g., the user 140, the user of the user device 180, or a merchant associated with the merchant server 120, etc.) may access a user account associated with the user and access various services offered by the service provider server 130, by generating HTTP requests directed at the service provider server 130.

The service provider server 130, in one embodiment, is configured to maintain one or more user accounts and merchant accounts in an accounts database 136, each of which may be associated with a profile and may include account information associated with one or more individual users (e.g., the user 140 associated with user device 110, etc.) and merchants. For example, account information includes private financial information of users and merchants, such as one or more account numbers, passwords, credit card information, banking information, digital wallets used, or other types of financial information, transaction history, Internet Protocol (IP) addresses, device information associated with the user account. In certain embodiments, account information also includes user purchase profile information such as account funding options and payment options associated with the user, payment information, receipts, and other information collected in response to completed funding and/or payment transactions. It is noted that the accounts database 136 (and/or any other database used by the system disclosed herein may be implemented within the service provider server 130 or external to the service provider server 130 (e.g., implemented in a cloud, etc.).

In one implementation, a user has identity attributes stored with the service provider server 130, and the user has credentials to authenticate or verify identity with the service provider server 130. User attributes may include personal information, banking information and/or funding sources. In various aspects, one or more of the user attributes are passed to the service provider server 130 as part of a login, search, selection, purchase, and/or payment request, and the user attributes may be utilized by the service provider server 130 to associate the user with one or more particular user accounts maintained by the service provider server 130 and used to determine the authenticity of a request from a user device.

In various embodiments, the service provider server 130 also includes a logic module 132 that implements the framework as discussed herein. In some embodiments, the logic module uses an AI model to perform complex tasks that use logic induction, such as generating suspicious activity reports as illustrated above. For example, as service provider server 130 conducts transactions for users (e.g., the user 140 of the user device 110, the merchant associated with the merchant server 120), the service provider server 130 may be requested to identify occurrences of suspicious activities (e.g., fraudulent transactions, money laundering activities, financial crime activities, etc.) and to generate reports (e.g., suspicious activity reports) for the identified activities. The report for an activity may include descriptions of a combination of events that have occurred and associated with the activity, and the logical reasoning for why the combination of events is associated with a suspicious activity. As discussed here, the task of generating this type of reports is historically challenging for generic AI models. As such, the logic module 132 may provide processes and resources according to the framework to enable an AI model to perform logic inductions.

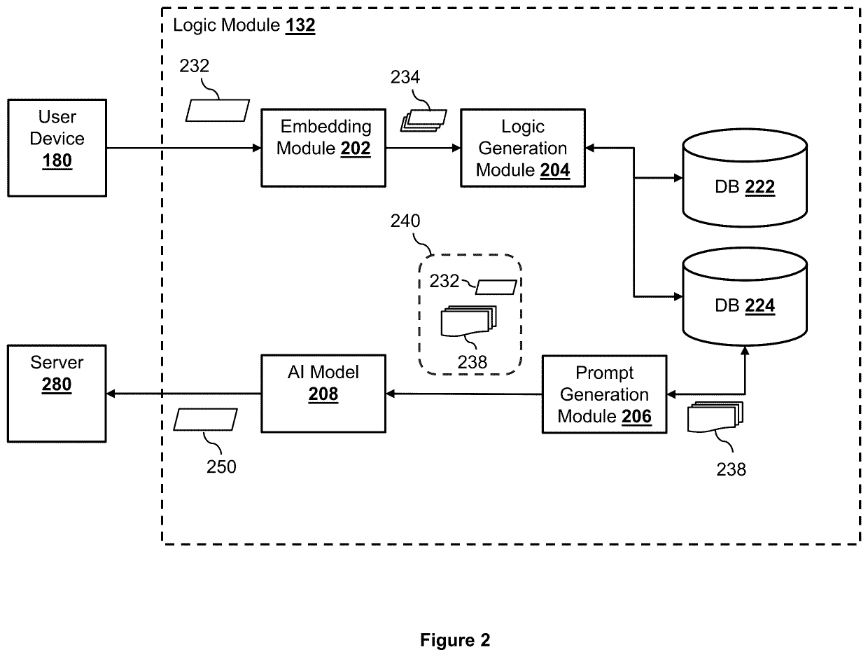

FIG. 2 illustrates a block diagram of the logic module 132 according to an embodiment of the disclosure. The logic module 132 includes an embedding module 202, a logic generation module 204, a prompt generation module 206, an AI model 208, and databases 222 and 224. As discussed herein, the logic induction capabilities are provided to the AI model 208 under the framework in two stages—the preparation stage and the generation stage. During the preparation stage, the logic module 132 generates a data structure that represents logics based on historical events. For example, using the suspicious activity report example illustrated above, the logic module 132 may retrieve narratives of activities that have been previously identified to be associated with a particular type (e.g., suspicious activities, etc.) from the database 222. The logic generation module 204 may extract aspects from the narrative of each activity, and generate a graph representing the logic of each activity (e.g., logical relationships among different aspects associated with each activity, etc.). In some embodiments, the logic generation module 204 also generates guiding questions for each logic, and stores the logic (e.g., embeddings generated based on the graph) and guiding questions as key/value pairs in the database 224. The key/value pairs become the logic knowledge source for the AI model 208.

During the generation stage, the logic module 132 may receive a request to perform a task that requires logic induction. Using the suspicious activity report example illustrated above, the request may include a narrative 232 of a new activity that has been determined to be associated with a particular activity type (e.g., suspicious activity, etc.). In some embodiments, the narrative 232 also includes a list of risk factors. For example, a user of the user device 180 (e.g., an agent of the service provider server 130) or a computer module that is part of the service provider server 130 may monitor transactions that are conducted through the service provider server 130. The user and/or the computer module may identify a particular sequence of transactions that, when analyzed together, is associated with an activity of the particular type. The user and/or the computer module may generate a narrative that describes the sequence of the events associated with the activity.

The embedding module 202 may extract aspects from the narrative 232, and generate embeddings 234 based on the aspects. The logic generation module 204 may query the database 224 based on the embeddings 234. For example, the logic generation module 204 may identify one or more keys from the database 224 that match the embeddings 234. The logic generation module 204 may then retrieve the guiding questions 238 corresponding to the one or more keys.

The prompt generation module 206 may generate a prompt 240 for the AI model 208 for performing the requested task. More importantly, the prompt 240 that is generated by the prompt generation module 206 enables the AI model 208 to generate content that follows a particular logic flow. For example, the prompt generation module 206 may incorporate the narrative 232 and the guiding questions 238 retrieved from the database 224 into the prompt 240. The prompt generation module 206 may also insert instructions for the AI model 208 to perform the task (e.g., instructing the AI model 208 to generate a report that describes the events associated with the activity and the reasons for determining that the activity is associated with a particular activity type based on the event).

Based on the prompt 240, the AI model 208 may determine answers for the guiding questions 238 based on the narrative 232, and may use the answers to the guiding questions 238 to formulate the reasoning of how the events associated with the activity lead to a determination that the activity is associated with the particular activity type based on the logic behind the guiding questions. The AI model 208 may produce an output 250 (e.g., a report the explains the reasons for determining that the activity is associated with the particular activity type). The logic module 132 may provide the output 250 to a server 280, which in turn may further process the output 250. For example, the server 280 may be associated with the service provider server 130, and may use the reasoning included in the output 250 to adjust one or more components of the service provider server 130 (e.g., adjusting one or more parameters of the service application 138) in order to affect the frequency of activities of the particular activity type (e.g., reducing or increasing the frequency of activities of the particular activity type, etc.) In some embodiments, when the service application 138 uses one or more machine learning models to assess a risk of a transaction, the server 280 may modify one or more parameters of the one or more machine learning models, such that the one or more machine learning models will be more (or less) likely to increase (or decrease) a risk of a transaction. The risk level that is assessed to the transactions may affect the manner in which the service application 138 processes the transactions (e.g., authorizing a transaction with a risk level below a threshold, denying a transaction with a risk level above the threshold, requesting for additional information, etc.).

In some embodiments, the server 280 is associated with an entity (e.g., a government agency) that is external to the service provider server 130. In such embodiments, the output 250 is transmitted to the server 280 as part of one or more reports provided by the service provider for complying one or more rules or regulations.

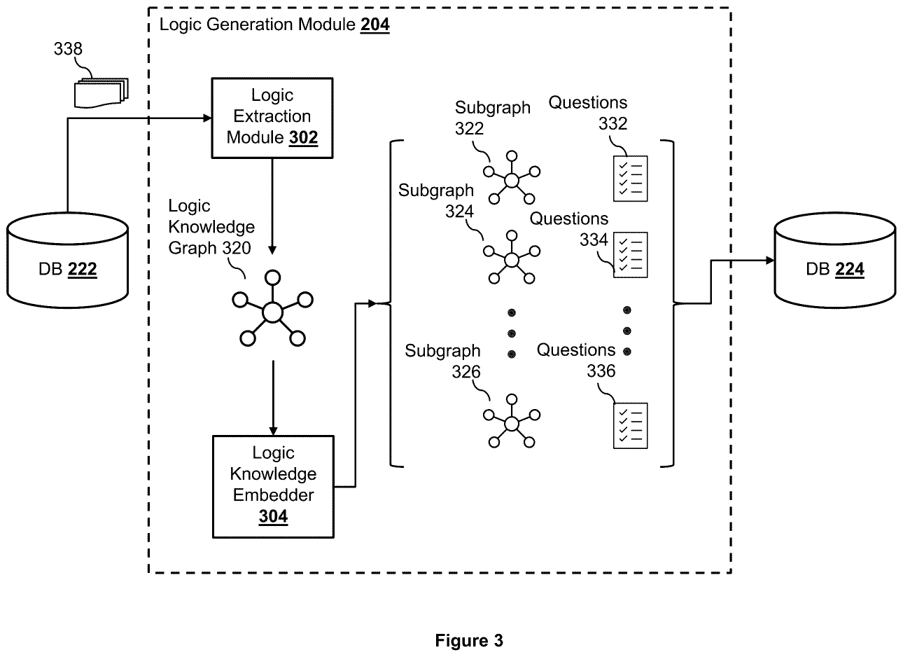

FIG. 3 illustrates a block diagram of the logic generation module 204 according to an embodiment of the disclosure. The logic generation module 204 includes a logic extraction module 302 and a logic knowledge embedder 304. During the preparation stage, the logic extraction module 302 retrieves narratives 338 of previously identified activities from the database 222. For example, the narrative of a money laundering activity may include “upon receipt of payments, User ‘AAA’ transferred the funds back to User ‘BBB;’ none of the payments included notes to provide insight as to what the payments were for; upon receipt of the payments, User ‘BBB’ withdrew the funds and transferred money back to User ‘AAA.”’

The logic extraction module 302 may then generate graphs for each activity based on the corresponding narrative. For example, the logic extraction module 302 may first extracts aspects from the narratives. Aspects are abstractions of individual characteristics associated with one or more events that led up (or contributed) to the occurrence of the activity. Each aspect may represent an individual characteristic that can be combined with other aspects in a logic flow that gives rise to the occurrence of an activity. However, each aspect may lack details that are unique to the activity (e.g., identities of the parties involved in a transaction, a specific amount of funds associated with a transaction, etc.). In some embodiments, the logic extraction module 302 uses a machine learning model (e.g., a language model) to generate the aspects based on the narratives 338. The machine learning model may derive multiple individual components (e.g., characteristics) that contribute to the activity based on each of the narratives 338, and may generate descriptions for each of the individual components based on summarizing the descriptions associated with each individual component and removing any information specific to the event. For example, the logic extraction module 302 may generate, based on the narrative example provided above, the following aspects:
(1) Funds Transfers Between Parties: upon receipt of the payments, Party A transferred the funds back to Party B. Upon receipt of the payments, Party B transferred the funds back to Party A after withdrawing the funds.
(2) Lack of Payment Notes: none of the payments included notes to provide insight into what the payments were for.
(3) Funds Withdrawal: upon receipt of the payments, Part B withdrew the funds.

After extracting the aspects of the activity, the logic extraction module 302 may generate a graph to represent the logics (e.g., the logical relationships among the aspects) associated with each activity. The logical relationships may include a directional flow among the aspects. For example, for the aspects extracted from the potential money laundering activity illustrated above, the logic extraction module 302 may generate a graph that includes nodes for representing the aspects, and generate connections (e.g., edges) to link the related aspects.

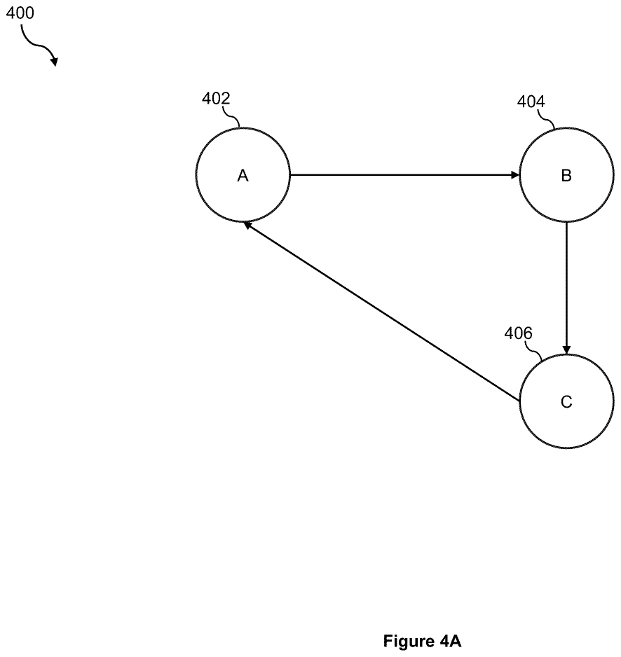

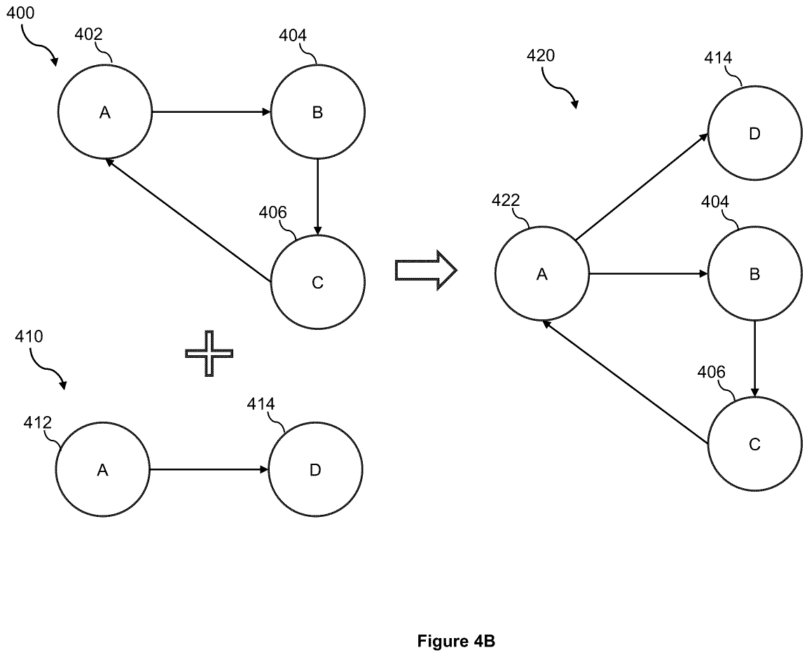

FIG. 4A illustrates an example graph 400 that the logic extraction module 302 generates for the narrative example illustrated above. As shown, the graph 400 includes three nodes 402, 404, and 406 representing the three aspects, respectively. In this example, the first node 402 corresponds to the first aspect (e.g., Aspect ‘A’) representing funds transfers between parties, the second node 404 corresponds to the second aspect (e.g., Aspect ‘B’) representing the lack of payment notes, and the third node 406 corresponds to the third aspect (e.g., Aspect ‘C’) representing funds withdrawal. To generate the graph 400, the logic extraction module 302 may link the node 402 representing funds transfers between parties to the node 404 representing the lack of payment notes (as the lack of payment notes depend on the funds transfers between the parties), link the node 404 representing the lack of payment notes to the node 406 representing funds withdrawal (as the funds withdrawal comes after the funds transfers that lack payment notes), and link the node 406 representing funds withdrawal back to the node 402 representing funds transfers between parties (as another funds transfer occurred after the funds withdrawal).

Referring back to FIG. 3, the logic extraction module 302 may continue to generate additional graphs that represent logics associated with other activities based on the narratives retrieved from the database 222. For example, the logic extraction module 320 may generate graphs 322, 324, 326, etc. After generating individual graphs (also referred to as “sub-graphs”) for each activity based on the narratives associated with the activities, the logic extraction module 302 may merge the graphs to form a logic knowledge graph 320.

The merging of the graphs (e.g., the graphs 322, 324, 326, etc.) may include removing duplicated graphs. For example, since different combinations of events that lead up to the activities of the same type often include the same aspects and the same relationships among the aspects (e.g., same aspect flows that differ only in the parties'identities and amounts, etc.), the logic extraction module 302 may retain only one graph to represent those activities that are associated with the same aspect flow (e.g., the same event combinations) when generating the logic knowledge graph 320. In some embodiments, the logic extraction module 302 adjusts the weight of a link (e.g., a connection, an edge, etc.) in the logic knowledge graph between two aspects when multiple activities are associated with the same relationship between the two aspects.

In some embodiments, the merging also includes generating a larger graph by combining multiple graphs. For example, if two graphs associated with two different activities share one or more aspects (e.g., have one or more common aspects), the logic extraction module 302 may merge the shared aspect(s) (e.g., combining the different nodes representing the same shared aspect into a single node, etc.) such that the merged graph may include aspects/relationships that represent two or more different logics associated with different activities and/or different activity types.

FIG. 4B illustrates the merging of two sub-graphs according to an embodiment of the disclosure. Specifically, FIG. 4B shows two separate graphs 400 and 410 representing the logics of two different activities. Specifically, the graph 400 represents the logic of the money laundering activity as illustrated above, and includes three nodes 402, 404, and 406 representing three aspects, respectively (e.g., Aspect ‘A,’ Aspect ‘B,’ and Aspect ‘C’). The graph 410 represents the logic of another activity, and includes two nodes 412 and 414 representing two aspects respectively (e.g., Aspect ‘A’ and Aspect ‘D’). Since both of the graphs 400 and 410 include a node (e.g., node 402 for the graph 400 and node 412 for the graph 410) that represents the same aspect (e.g., Aspect ‘A’), the graphs 400 and 410 may be merged to generate a combined graph 420. The combined graph 420 includes a new node 422 that represents the result of merging the node 402 and 412 (both of which representing the same aspect). As shown, the node 422 is connected to both the node 404 (from the graph 400) and the node 414 (from the graph 410). As such, after the merging, the shared aspect(s) may be connected to different aspects (e.g., the node 422 representing the shared Aspect ‘A’ is connected to both the node 404 and the node 414 after the merging) based on the different graphs that were merged.

Referring back to FIG. 3, based on the merging of different graphs representing different activities, the logic knowledge graph 320 enables the logic generation module 204 to determine comprehensive characteristics of each aspect. For example, since the same aspect may be associated with different combinations of events related to different activities, the logic generation module 204 may use the logic knowledge graph 320 to determine the aspect's relationships with other different aspects that are associated with the different event combinations (e.g., different activities). This approach enables the logic generation module 204 to comprehensively understand the relationships (e.g., interactions) among the aspects.

To extract the characteristics of the aspects and the different logics represented by the logic knowledge graph 320, the logic generation module 204 may use the logic knowledge embedder 304 to generate embeddings for each aspect (e.g., each node) in the logic knowledge graph 320. The embeddings may represent attributes associated with each aspect, such as its relationships to other aspects in the logic knowledge graph 320, a strength of each of the relationships, characteristics of a portion of the logic knowledge graph 320 in which the aspect is located, etc. The logic knowledge embedder 304 may then use a graph neural network to analyze the embeddings associated with the aspects in the logic knowledge graph. For example, the logic knowledge embedder 304 may use the graph neural network to analyze the similarities and/or differences between different logics represented by the different graphs (or sub-graphs) within the logic knowledge graph 320 based on the embeddings. The logic knowledge embedder 304 may then capture the analytical information as additional embeddings, and associate the embeddings with different portions of the logic knowledge graph 320 (e.g., the different sub-graphs). In some embodiments, by learning and analyzing the logic embeddings across different activities and activity types, the logic generation module 204 may also infer additional logics. For example, the logic generation module 204 may expand the logic knowledge graph 320 by generating new connections between aspects based on the analyses of the existing connections among the aspects.

In some embodiments, the logic generation module 204 constructs a logic database (e.g., the database 224) for the AI model 208 based on the knowledge captured from the logic knowledge graph 320. The database 224 may serve as a logic knowledge base for the AI model 208, such that the AI model 208 can use the information from the database 224 to induce logic when performing tasks (e.g., analyzing and generating reasoning for new events). The database 224 may include the different sub-graphs (e.g., graphs 322, 324, 326, etc.). Since each sub-graph includes unique logic embeddings that represent the logical relationships among a combination of different aspects, the AI model 208 may use the knowledge derived from each logic to perform the task.

However, it has been contemplated that the sub-graphs alone may not be sufficient in enabling the AI model 208 to induce logic based on a narrative. As such, the logic generation module 204 may also generate a set of guiding questions for each sub-graph (e.g., for each logic) that can assist the AI model in understanding and utilizing the corresponding logics represented by the sub-graphs. Guiding questions are effective for AI models because they provide context, structure, and focus. Furthermore, guiding questions help the AI model 208 to break down the logic and reasoning into distinct steps, enabling the AI model 208 to generate narratives (e.g., reports) with accurate and coherent logic. Using the example illustrated above, the logic generation module 204 may generate the following guiding questions for the logic that represents the potential money laundering activity as illustrated above:
1. Who are the parties involved in the fund transfers?
2. How frequently are the funds transferred between these parties?
3. What is the total amount of funds transferred between these parties?
4. Are there any notes or descriptions accompanying the payments?
5. If not, how might the absence of notes impact the understanding of the purpose of these transactions?
6. How soon after the receipt of funds are the withdrawals made?
7. What are the destinations of the withdrawn funds?8. How frequently does this cycle of transferring, withdrawing, and re-transferring
occur?

In some embodiments, the logic generation module 204 may use a machine learning model (e.g., a large language model) to generate the guiding questions based on each of the sub-graphs (e.g., the graphs 322, 324, 326, etc.). The logic generation module 204 may then store the sub-graphs 322, 324, 326, and the corresponding guiding questions in the database 224. In some embodiments, the logic generation module 204 may store the embeddings associated with each of the sub-graphs and the corresponding guiding questions according to a key/value scheme, where embeddings associated with the sub-graphs are stored as keys and the corresponding guiding questions are stored as values for the keys. This way, the AI model 208 and/or the prompt generation module 206 may look up the guiding questions based on matching embeddings associated with a new narrative with one or more keys in the database 224.

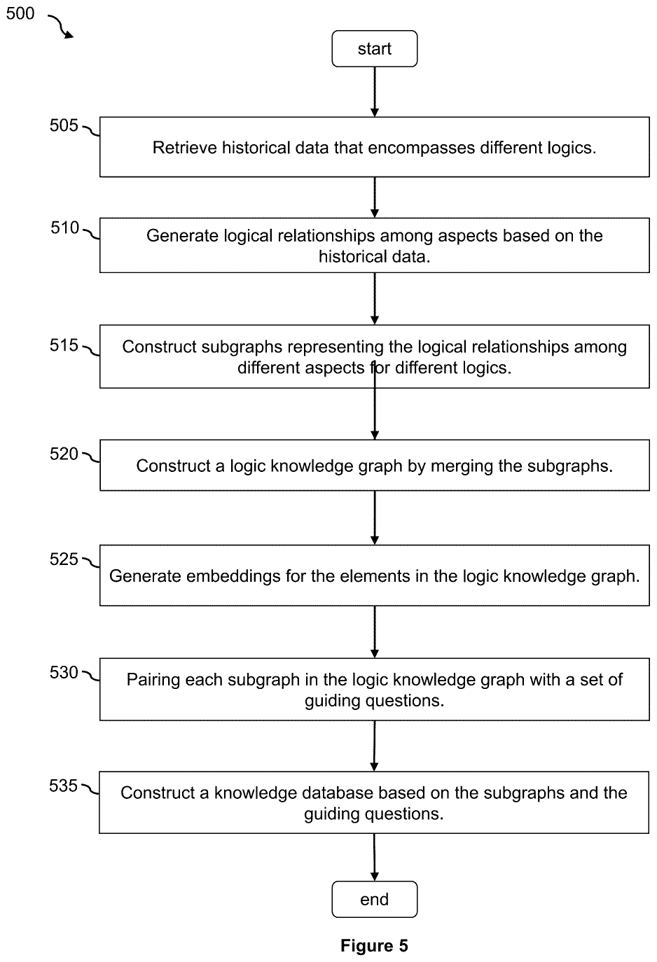

FIG. 5 illustrates a process 500 for generating a logic database for an AI model according to various embodiments of the disclosure. In some embodiments, at least a portion of the process 500 is performed by the logic module 132, although one or more steps may be performed by one or more of the components/devices/modules/systems described herein. The process 500 begins by retrieving (at step 505) historical data that encompasses different logics. For example, the logic generation module 204 of the logic module 132 may retrieve narratives of activities that have been assigned to a particular activity type (e.g., suspicious activity, etc.). The narratives incorporated reasoning regarding why a combination of events has led to a determination that an activity of the particular activity type is likely according to pre-determined logic.

The logic module 132 then generates (at step 510) logical relationships among aspects based on the historical data and constructs (at step 515) subgraphs representing the logical relationships among different aspects for different logics. For example, the logic extraction module 302 may extract aspects from each narrative. Each aspect represents an individual characteristic from the corresponding narrative, that when combined with other aspects, form a logical sequence that lead to the determination of an occurrence of the activity. After extracting the aspects from each narrative associated with an activity, the logic extraction module 302 may construct a graph for each activity by connecting the corresponding aspects in a logical manner. For example, the logic extraction module 302 may generate nodes representing the aspects for each activity. Since the aspects associated with an activity can form logical relationships with each other, the logic extraction module 302 may connect the nodes representing the aspects in a manner that represents the logical relationships among the aspects. For example, if a first aspect describes a characteristic associated with a first event (e.g., funds transfer) that occurs before a second event (e.g., funds withdrawal) described in a second aspect, the logic extraction module 302 may provide a directional edge that links a first node representing the first aspect to a second node representing the second aspect.

In another example, if a first aspect describes a characteristic of a condition (e.g., lack of payment notes) associated with an event (e.g., funds transfer) described in a second aspect, the logic extraction module 302 may provide a directional edge that links a first node representing the event to a second node representing the condition. The logic generation module 403 may construct different graphs for the different activities based on the corresponding narratives.

The logic module 132 then constructs (at step 520) a logic knowledge graph by merging the subgraphs and generates (at step 525) embeddings for the elements in the logic knowledge graph. For example, the logic extraction module 302 may merge all of the graphs to form a logic knowledge graph. The merging may involve removing duplicate graphs and merging nodes that represent the same aspect. After the merging, the logic knowledge graph represents relationships among different aspects for multiple different logics. The logic knowledge embedder 304 may then generates embeddings for each node in the logic knowledge graph. The embeddings may represent attributes associated with each aspect, such as its relationships to other aspects in the logic knowledge graph, a strength of each of the relationships, characteristics of a portion of the logic knowledge graph in which the aspect is located, etc.

The logic module 132 pairs (at step 530) each subgraph in the logic knowledge graph with a set of guiding questions and constructs (at step 535) a knowledge database based on the subgraphs and the guiding questions. For example, since logic graphs can be a challenge for an AI model to comprehend, guiding questions can be generated based on the logic graphs. The guiding questions can be generated such that by answering the guiding questions, it will lead the AI model to follow the logic according to the logic graphs. The logic generation module 204 may construct the logic database based on the embeddings and the guiding questions. For example, the embeddings associated with each subgraph can be stored as a key in a key/value pair, and the corresponding guiding questions can be stored as the value in the key/value pair in the logic database.

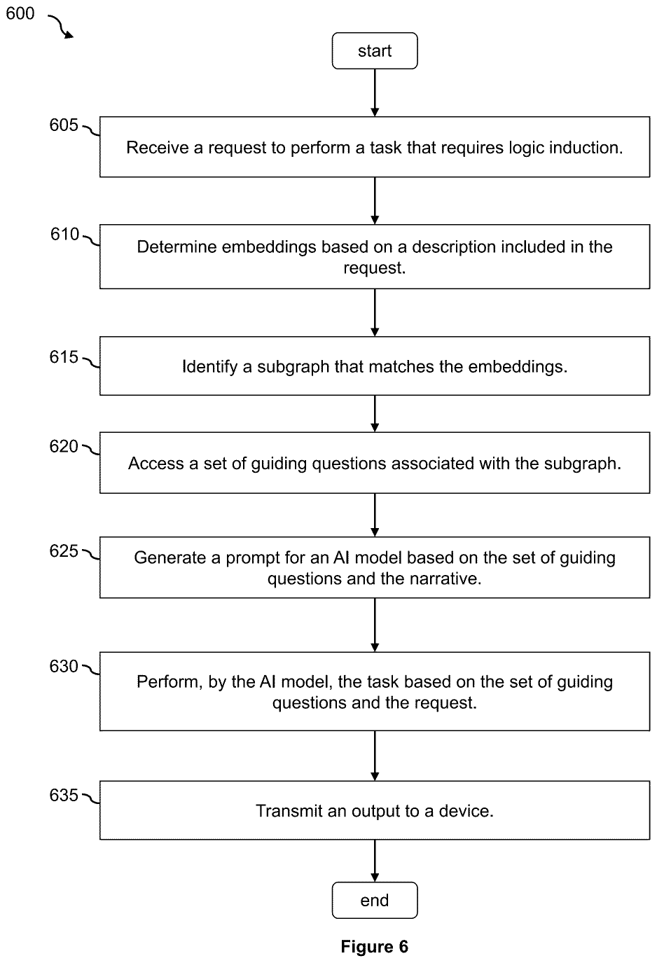

FIG. 6 illustrates a process 600 for using an AI model to perform a task that uses logic induction according to various embodiments of the disclosure. In some embodiments, at least a portion of the process 600 is performed by the logic module 132, although one or more steps may be performed by one or more of the components/devices/modules/systems described herein. The process 600 begins by receiving (at step 605) a request to perform a task that uses logic induction. For example, the logic module 132 may receive a narrative 232 associated with an activity from the user device 180, and is requested to generate a report based on the narrative 232. The report may include a logical explanation of how the different events described in the narrative lead to a determination that the activity is associated with a particular activity type (e.g., a suspicious activity, etc.).

The logic module 132 may use the framework disclosed herein to enable an AI model to generate the report. For example, the logic module 132 determines (at step 610) embeddings based on a description included in the request, identifies (at step 615) a subgraph that matches the embeddings, and accesses (at step 620) a set of guiding questions associated with the subgraph. For example, the embedding module 202 may extract different aspects from the narrative 232 (e.g., by removing information that is unique to the narrative 232, and identify various event characteristics described in the narrative 232). The embedding module 202 may then generate embeddings based on the aspects, and query the database 224 based on the embeddings. If one or more keys (e.g., embeddings associated with different subgraphs of the logic knowledge graph 320 are determined to match the embeddings of the narrative 232, the database 224 may return the guiding questions 238 corresponding to the keys.

The logic module 132 then generates (at step 625) a prompt for an AI model based on the set of guiding questions and the narrative. The prompt enables the AI model to perform (at step 630) the task. For example, the prompt generation nodule 206 may generate the prompt 240 to include the narrative 232 and the guiding questions 238, and may provide the prompt 240 to the AI model 208. Based on the prompt, the AI model 208 may generate a report that provides a logical explanation of how the different events described in the narrative 232 lead to a determination that the activity is associated with a particular activity type (e.g., a suspicious activity, etc.). The logic module 132 then transmits (at step 635) the report to a device (e.g., the server 280).

In some embodiments, instead of providing an explanation in a report the AI model 208 generates an output that indicates a classification of the activity based on the logic retrieved from the database 224. For example, when logic module 132 receives information associated with a new activity, the logic module may generate a prompt that includes the information and various logics (e.g., embeddings) from the database 224, and the AI model 208 may be configured to determine a classification of the activity based on whether the activity matches any of the logics from the database 224. If it is determined that the activity is associated with a particular type of activity (e.g., suspicious activity), the AI model 208 may then proceed to generate a report using the corresponding guiding questions from the database 224.

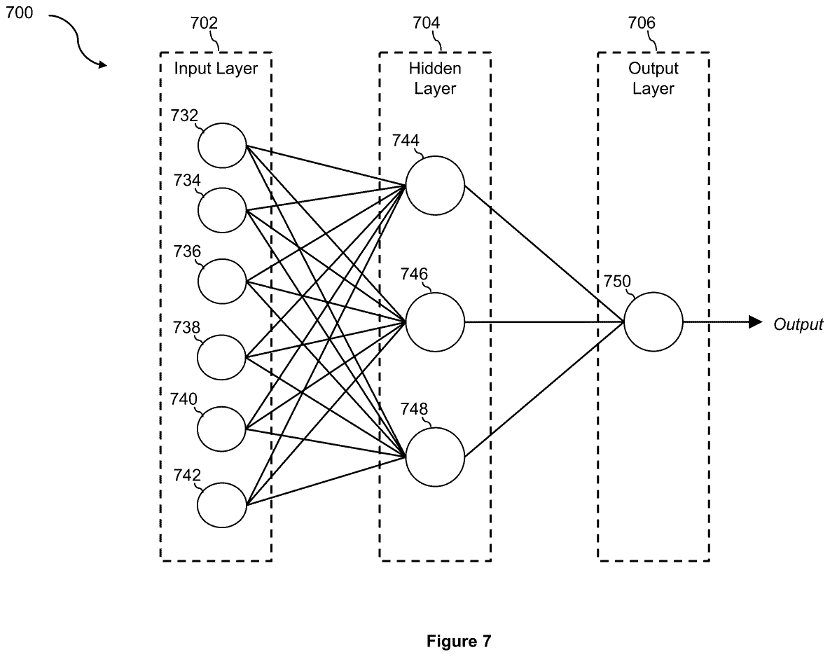

FIG. 7 illustrates an example artificial neural network 700 that may be used to implement a machine learning model, such as the AI model 208. As shown, the artificial neural network 700 includes three layers-an input layer 702, a hidden layer 704, and an output layer 706. Each of the layers 702, 704, and 706 may include one or more nodes (also referred to as “neurons”). For example, the input layer 702 includes nodes 732, 734, 736, 738, 740, and 742, the hidden layer 704 includes nodes 744, 746, and 748, and the output layer 706 includes a node 750. In this example, each node in a layer is connected to every node in an adjacent layer via edges and an adjustable weight is often associated with each edge. For example, the node 732 in the input layer 702 is connected to all of the nodes 744, 746, and 748 in the hidden layer 704. Similarly, the node 744 in the hidden layer is connected to all of the nodes 732, 734, 736, 738, 740, and 742 in the input layer 702 and the node 750 in the output layer 706. While each node in each layer in this example is fully connected to the nodes in the adjacent layer(s) for illustrative purpose only, it has been contemplated that the nodes in different layers can be connected according to any other neural network topologies as needed for the purpose of performing a corresponding task.

The hidden layer 704 is an intermediate layer between the input layer 702 and the output layer 706 of the artificial neural network 700. Although only one hidden layer is shown for the artificial neural network 700 for illustrative purpose only, it has been contemplated that the artificial neural network 700 used to implement any one of the computer-based models may include as many hidden layers as necessary. The hidden layer 704 is configured to extract and transform the input data received from the input layer 702 through a series of weighted computations and activation functions.

In this example, the artificial neural network 700 receives a set of inputs and produces an output. Each node in the input layer 702 may correspond to a distinct input. For example, when the artificial neural network 700 is used to implement the AI model 208, the nodes in the input layer 702 may correspond to different parameters and/or attributes of a prompt (which may be generated based on guiding questions from a logic database).

In some embodiments, each of the nodes 744, 746, and 748 in the hidden layer 704 generates a representation, which may include a mathematical computation (or algorithm) that produces a value based on the input values received from the nodes 732, 734, 736, 738, 740, and 742. The mathematical computation may include assigning different weights (e.g., node weights, edge weights, etc.) to each of the data values received from the nodes 732, 734, 736, 738, 740, and 742, performing a weighted sum of the inputs according to the weights assigned to each connection (e.g., each edge), and then applying an activation function associated with the respective node (or neuron) to the result. The nodes 744, 746, and 748 may include different algorithms (e.g., different activation functions) and/or different weights assigned to the data variables from the nodes 732, 734, 736, 738, 740, and 742 such that each of the nodes 744, 746, and 748 may produce a different value based on the same input values received from the nodes 732, 734, 736, 738, 740, and 742. The activation function may be the same or different across different layers. Example activation functions include but not limited to Sigmoid, hyperbolic tangent, Rectified Linear Unit (ReLU), Leaky ReLU, Softmax, and/or the like. In this way, after a number of hidden layers, input data received at the input layer 702 is transformed into rather different values indicative data characteristics corresponding to a task that the artificial neural network 700 has been designed to perform.

In some embodiments, the weights that are initially assigned to the input values for each of the nodes 744, 746, and 748 may be randomly generated (e.g., using a computer randomizer). The values generated by the nodes 744, 746, and 748 may be used by the node 750 in the output layer 706 to produce an output value (e.g., a response to a user query, a prediction, etc.) for the artificial neural network 700. The number of nodes in the output layer depends on the nature of the task being addressed. For example, in a binary classification problem, the output layer may consist of a single node representing the probability of belonging to one class (as in the example shown in FIG. 7). In a multi-class classification problem, the output layer may have multiple nodes, each representing the probability of belonging to a specific class. When the artificial neural network 700 is used to implement the AI model 208, the output node 750 may be configured to generate a report.

In some embodiments, the artificial neural network 700 may be implemented on one or more hardware processors, such as CPUs (central processing units), GPUs (graphics processing units), FPGAs (field-programmable gate arrays), Application-Specific Integrated Circuits (ASICs), dedicated AI accelerators like TPUs (tensor processing units), and specialized hardware accelerators designed specifically for the neural network computations described herein, and/or the like. Example specific hardware for neural network structures may include, but not limited to Google Edge TPU, Deep Learning Accelerator (DLA), NVIDIA AI-focused GPUs, and/or the like. The hardware used to implement the neural network structure is specifically configured based on factors such as the complexity of the neural network, the scale of the tasks (e.g., training time, input data scale, size of training dataset, etc.), and the desired performance.

The artificial neural network 700 may be trained by using training data based on one or more loss functions and one or more hyperparameters. By using the training data to iteratively train the artificial neural network 700 through a feedback mechanism (e.g., comparing an output from the artificial neural network 700 against an expected output, which is also known as the “ground-truth” or “label”), the parameters (e.g., the weights, bias parameters, coefficients in the activation functions, etc.) of the artificial neural network 700 may be adjusted to achieve an objective according to the one or more loss functions and based on the one or more hyperparameters such that an optimal output is produced in the output layer 706 to minimize the loss in the loss functions. Given the loss, the negative gradient of the loss function is computed with respect to each weight of each layer individually. Such negative gradient is computed one layer at a time, iteratively backward from the last layer (e.g., the output layer 706 to the input layer 702 of the artificial neural network 700). These gradients quantify the sensitivity of the network's output to changes in the parameters. The chain rule of calculus is applied to efficiently calculate these gradients by propagating the gradients backward from the output layer 706 to the input layer 702.

Parameters of the artificial neural network 700 are updated backwardly from the last layer to the input layer (backpropagating) based on the computed negative gradient using an optimization algorithm to minimize the loss. The backpropagation from the last layer (e.g., the output layer 706) to the input layer 702 may be conducted for a number of training samples in a number of iterative training epochs. In this way, parameters of the artificial neural network 700 may be gradually updated in a direction to result in a lesser or minimized loss, indicating the artificial neural network 700 has been trained to generate a predicted output value closer to the target output value with improved prediction accuracy. Training may continue until a stopping criterion is met, such as reaching a maximum number of epochs or achieving satisfactory performance on the validation data. At this point, the trained network can be used to make predictions on new, unseen data, such as to predict a frequency of future related transactions.

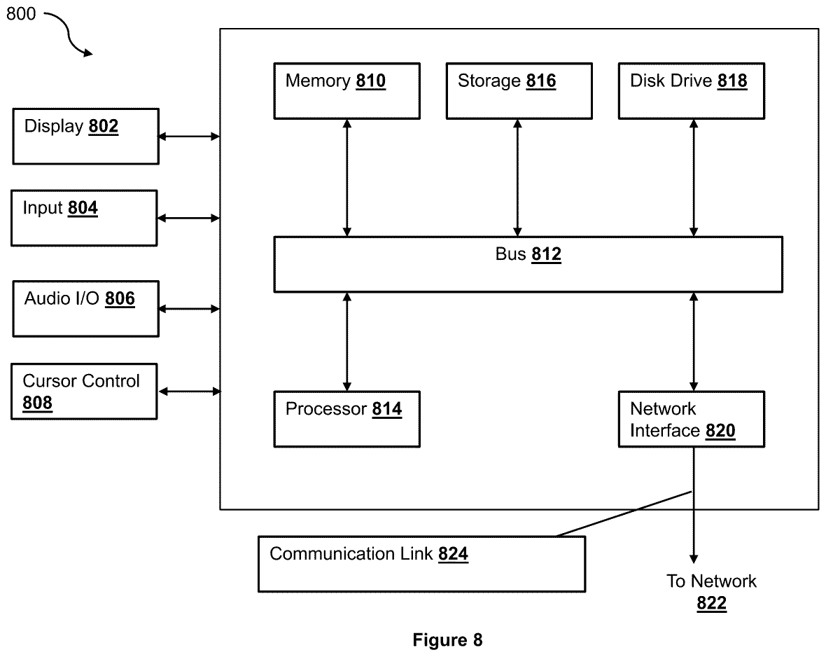

FIG. 8 is a block diagram of a computer system 800 suitable for implementing one or more embodiments of the present disclosure, including the service provider server 130, the merchant server 120, the user device 180, and the user device 110. In various implementations, each of the user devices 110 and 180 may include a mobile cellular phone, personal computer (PC), laptop, wearable computing device, etc. adapted for wireless communication, and each of the service provider server 130 and the merchant server 120 may include a network computing device, such as a server. Thus, it should be appreciated that the devices 110, 120, 130, and 180 may be implemented as the computer system 800 in a manner as follows.

The computer system 800 includes a bus 812 or other communication mechanism for communicating information data, signals, and information between various components of the computer system 800. The components include an input/output (I/O) component 804 that processes a user (i.e., sender, recipient, service provider) action, such as selecting keys from a keypad/keyboard, selecting one or more buttons or links, etc., and sends a corresponding signal to the bus 812. The I/O component 804 may also include an output component, such as a display 802 and a cursor control 808 (such as a keyboard, keypad, mouse, etc.). The display 802 may be configured to present a login page for logging into a user account or a checkout page for purchasing an item from a merchant. An optional audio input/output component 806 may also be included to allow a user to use voice for inputting information by converting audio signals. The audio I/O component 806 may allow the user to hear audio. A transceiver or network interface 820 transmits and receives signals between the computer system 800 and other devices, such as another user device, a merchant server, or a service provider server via a network 822. In one embodiment, the transmission is wireless, although other transmission mediums and methods may also be suitable. A processor 814, which can be a micro-controller, digital signal processor (DSP), or other processing component, processes these various signals, such as for display on the computer system 1100 or transmission to other devices via a communication link 824. The processor 814 may also control transmission of information, such as cookies or IP addresses, to other devices.

The components of the computer system 800 also include a system memory component 810 (e.g., RAM), a static storage component 816 (e.g., ROM), and/or a disk drive 818 (e.g., a solid-state drive, a hard drive). The computer system 800 performs specific operations by the processor 814 and other components by executing one or more sequences of instructions contained in the system memory component 810. For example, the processor 814 can perform the functionalities described herein, for example, according to the processes 500 and 600.

Logic may be encoded in a computer readable medium, which may refer to any medium that participates in providing instructions to the processor 814 for execution. Such a medium may take many forms, including but not limited to, non-volatile media, volatile media, and transmission media. In various implementations, non-volatile media includes optical or magnetic disks, volatile media includes dynamic memory, such as the system memory component 810, and transmission media includes coaxial cables, copper wire, and fiber optics, including wires that comprise the bus 812. In one embodiment, the logic is encoded in non-transitory computer readable medium. In one example, transmission media may take the form of acoustic or light waves, such as those generated during radio wave, optical, and infrared data communications.

Some common forms of computer readable media include, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer is adapted to read.

In various embodiments of the present disclosure, execution of instruction sequences to practice the present disclosure may be performed by the computer system 800. In various other embodiments of the present disclosure, a plurality of computer systems 800 coupled by the communication link 824 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The various features and steps described herein may be implemented as systems comprising one or more memories storing various information described herein and one or more processors coupled to the one or more memories and a network, wherein the one or more processors are operable to perform steps as described herein, as non-transitory machine-readable medium comprising a plurality of machine-readable instructions which, when executed by one or more processors, are adapted to cause the one or more processors to perform a method comprising steps described herein, and methods performed by one or more devices, such as a hardware processor, user device, server, and other devices described herein.

What is claimed is:

1. A system comprising:
a non-transitory memory; and
one or more hardware processors coupled with the non-transitory memory and configured to execute instructions from the non-transitory memory to cause the system to:
receive a narrative associated with an activity that has been assigned to an activity type;
query a logic database for a prompt template based on the narrative, wherein the logic database stores logic data associated with a plurality of activities and corresponding prompt templates, wherein each of the corresponding prompt templates comprises a corresponding set of questions usable to guide an artificial intelligence (AI) model to generate content that follows a corresponding logic;
generate a prompt for the AI model based on the narrative and a particular set of questions included in the prompt template; and
provide the prompt to the AI model, wherein the AI model is configured to generate the content based on the prompt.

2. The system of claim 1, wherein executing the instructions further causes the system to generate, using a graph neural network, embeddings representing a sequence of events associated with the activity based on the narrative, and wherein querying the logic database for the prompt template is further based on the embeddings.

3. The system of claim 1, wherein executing the instructions further causes the system to:
assign, using a machine learning model, the activity to the activity type based on a set of transactions associated with the activity.

4. The system of claim 1, wherein executing the instructions further causes the system to:
generate a plurality of graphs based on a plurality of narratives associated with the plurality of activities; and
generate a logic knowledge graph based on merging the plurality of graphs, wherein the logic data comprises embeddings generated based on the logic knowledge graph.

5. The system of claim 4, wherein executing the instructions further causes the system to:
generate the corresponding prompt templates for the plurality of graphs.

6. The system of claim 4, wherein executing the instructions further causes the system to:
identify a first graph and a second graph from the plurality of graphs that share one or more common nodes; and
merge the first subgraph with the second subgraph based on the one or more common nodes.

7. The system of claim 4, wherein executing the instructions further causes the system to:
determine a difference between the narrative and a portion of the logic data corresponding to the prompt template in the logic database;
modify the logic knowledge graph based on the difference; and
generate additional logic data for the logic database based on the modified logic knowledge graph.

8. A method comprising:
receiving, by a computer system, a request to generate content based on an activity;
querying, by the computer system, a logic database for a prompt template based on the activity, wherein the logic database stores logic data associated with a plurality of activities and corresponding prompt templates, wherein each of the corresponding prompt templates comprises a corresponding set of questions usable to guide an artificial intelligence (AI) model to generate the content based on a corresponding logic;
generating, by the computer system, a prompt for the AI model based on the activity and a particular set of questions included in the prompt template; and
causing, by the computer system, the AI model to generate the content based on the prompt.

9. The method of claim 8, wherein the AI model is configured to (i) generate responses to the particular set of questions based on a description of the activity and (ii) generate the content based on the responses.

10. The method of claim 8, further comprising:
adjusting one or more parameters of a machine learning model based on the content, wherein the machine learning model is configured to classify activities into different activity types.

11. The method of claim 8, further comprising:
generating, using a graph neural network, embeddings representing a sequence of events associated with the activity based on a description of the activity, and wherein the querying the logic database for the prompt template is further based on the embeddings.

12. The method of claim 8, wherein the particular set of questions is generated based on a particular logic, and wherein the content is generated to follow the particular logic.

13. The method of claim 12, wherein the activity is determined to be associated with a particular activity type, wherein the content comprises an explanation of how different events associated with the activity lead to a determination that the activity is associated with the particular activity type according to the particular logic.

14. The method of claim 8, wherein the logic data and the corresponding prompt templates are stored in the logic database as key-value pairs.

15. A non-transitory machine-readable medium having stored thereon machine-readable instructions executable to cause a machine to perform operations comprising:
receiving a description associated with an activity that has been assigned to a particular activity type;
querying a logic database for a prompt template based on the description, wherein the logic database stores logic data associated with a plurality of activities and corresponding prompt templates, wherein each of the corresponding prompt templates comprises a corresponding set of questions usable to guide an artificial intelligence (AI) model to generate content according to a corresponding logic;
generating a prompt for the AI model based on the description and a particular set of questions included in the prompt template; and
causing the AI model to generate the content based on the prompt.

16. The non-transitory machine-readable medium of claim 15, wherein the AI model is configured to (i) generate responses to the particular set of questions based on the description and (ii) generate the content based on the responses.

17. The non-transitory machine-readable medium of claim 15, wherein the operations further comprise:
adjusting one or more parameters of a machine learning model based on the content, wherein the machine learning model is configured to classify activities into different activity types.

18. The non-transitory machine-readable medium of claim 15, wherein the operations further comprise:
generating, using a graph neural network, embeddings representing a sequence of events associated with the activity based on the description, and wherein the querying the logic database for the prompt template is further based on the embeddings.

19. The non-transitory machine-readable medium of claim 15, wherein the particular set of questions is generated based on a particular logic, and wherein the content is generated to follow the particular logic.

20. The non-transitory machine-readable medium of claim 19, wherein the content comprises an explanation of how different events associated with the activity lead to a determination that the activity is associated with the particular activity type according to the particular logic.
